(19) United States
(12) Patent Application Publication
(10) Pub. No.: US 2026/0097861 A1
(43) Pub. Date: Apr. 9, 2026

(54) METHOD AND DEVICE FOR DETECTING AN ANOMALY IN THE OPERATION OF AN AIRCRAFT

(71) Applicant: SAFRAN AIRCRAFT ENGINES, Paris (FR)

(72) Inventors: Jean Charles Marie COUSSIROU, Moissy-Cramayel (FR); Thomas Emile VANARET, Moissy-Cramayel (FR)

(73) Assignee: SAFRAN AIRCRAFT ENGINES, Paris (FR)

(21) Appl. No.: 19/113,293

(22) PCT Filed: Sep. 22, 2023
(86) PCT No.: PCT/FR2023/051455

§ 371 Date: Mar. 19, 2025

(30) Foreign Application Priority Data
Sep. 22, 2022 (FR) FR2209635

(51) Int. Cl. B64F 5/60; B64D 33/00

(52) U.S. Cl. CPC B64F 5/60; B64D 33/00

(57) ABSTRACT

Method for detecting an operating anomaly of an aircraft component associated with at least one status indicator, said method—for at least one acquired time sequence (Seq1, Seq2) comprising acquired values of said at least one indicator—comprising steps of:
determining (E20) an approximated time sequence (Seq1*, Seq2*) of approximated values of said acquired values, by an approximation module (AE1, AE2);
determining (E30) a global anomaly score (A1, A2) for said acquired time sequence (Seq1, Seq2) from differences between said acquired values (Seq1, Seq2) and approximated values; and
detecting (E40) an operating anomaly of said component as a function of a comparison of said global anomaly score with a first threshold,
said approximation module being configured to minimize approximation errors between time sequences of reference values and time sequences of approximated values.

### PRIOR ART

The invention lies in the general field of methods for monitoring a system.

More particularly, the invention comes within the context of detecting an operating anomaly of one or more components of an aircraft. The invention finds particularly advantageous application, but in no way limiting, to the case of an aircraft comprising engines of turbine engine type.

An aircraft comprises components of which the operation is critical for the safety of the aircraft, and which must be monitored. For example, the oil circulation system is vital for proper functioning of an engine since it allows the lubrication and thermal regulation thereof. Any faults in said system can lead to engine shutdown in mid-flight.

To prevent such failures, prior art methods allow the detection of operating anomalies. An anomaly is an abnormal (operating) status of one or more components which can lead to the reduced or failed ability of these components to fulfil their functions.

Prior art methods allow the detection of pre-identified anomalies from instantaneous measurements (data of «snapshot» type) taken at only some flight phases.

However, operating anomalies not covered by existing algorithms may occur without being detected.

### DISCLOSURE OF THE INVENTION

It is the objective of the present disclosure to overcome all or some of the shortcomings of the prior art, in particular those set forth above, by proposing a solution allowing efficient monitoring of an aircraft component.

For this purpose, in a first aspect, there is proposed a method for detecting an operating anomaly, in relation to reference values, of at least one aircraft component associated with at least one status indicator (the component being associated with the status indicator), said method—for at least one acquired time sequence (e.g. the method comprises the acquisition of the acquired time sequence) comprising successive acquired values of said at least one indicator at different instants throughout the operation of said at least one component—comprising steps of:
determining an approximated time sequence comprising approximated values of said acquired values at said instants, approximation being performed by an approximation module;
determining a global anomaly score for said acquired time sequence from differences between said acquired values and said approximated values; and
detecting an operating anomaly of said component as a function of a comparison of the global anomaly score with a first threshold,
said approximation module previously being configured to minimize approximation errors between time sequences of reference values and time sequences of values approximated from said reference values, said reference values being representative of normal operation, such that approximation errors between said acquired values and said approximated values are greater if the acquired values are representative of abnormal operation.

Correlatively, in a second aspect of the invention, there is proposed a device for detecting an operating anomaly, in relation to reference values, of at least one aircraft component associated with at least one status indicator, said device—for at least one acquired time sequence comprising successive acquired values of said at least one indicator at different instants throughout operation of said at least component—comprising:
a module to determine an approximated time sequence comprising approximated values of said acquired values at said instants, approximation being performed by an approximation module;
a module to determine a global anomaly score for said acquired time sequence from differences between said acquired values and said approximated values; and
a module to detect an operating anomaly of said component as a function of a comparison of said global anomaly score with a first threshold,
said approximation module previously being configured to minimize approximation errors between time sequences of reference values and time sequences of values approximated from said reference values, said reference values being representative of normal operation, such that approximation errors between said acquired values and said approximated values are greater if the acquired values are representative of abnormal operation.

In general, the invention allows the monitoring of an aircraft component. In particular, the invention allows the detection of an operating anomaly of a component. By component, it is meant a stand-alone element (e.g. a sensor) or a functional assembly of elements (e.g. an oil circulation system to lubricate and thermally regulate a turbine), an electronic control system of an aircraft, a fuel circulation system, or a turbine). The method can be applied to several components.

The method can be implemented «on the ground» for example via analysis of status indicators measured at different flight phases, including in particular the phases of taxiing, take-off, in-flight, landing.

With this method, it is therefore possible to detect abnormal operation of a component which occurred during a flight of the aircraft, and to prevent potential malfunction during future flights.

This method is based on status indicators associated with the component. By status indicator associated with the component, it is meant herein a quantity dependent upon the operating of the component. For example, if this component is an oil circulation system of the aircraft engine, status indicators can be oil temperature, oil pressure, or the rotation speed of an engine turbine, since this speed is dependent on lubrication of the turbine by the oil system.

Values measured by these indicators over time form a time sequence. By acquired time sequence, it is therefore meant status indicator values successively measured throughout a flight time by specific sensors and recorded, or else values calculated from said measured values. Each value is associated with an instant e.g. the instant corresponding to measurement of this value. For example, a time sequence may contain values of oil temperature and pressure measured every second during the flight of the aircraft. In this example, each element of this sequence corresponds to a vector comprising a temperature value and pressure value measured at a given instant.

Therefore, an acquired time sequence for a component represents the functioning of the component over a flight timeframe.

An approximated time sequence is the reproduction by a so-called approximation module of a time sequence from partial data on the time sequence. The date associated with each element of the approximated sequence corresponds to the date of an element in the acquired sequence.

For example, an approximation module performs a regression from values of a sequence corresponding to a timeframe, from values of the acquired sequence corresponding to a date later than this timeframe.

In another example, the approximation module is an autoencoder which projects the acquired sequence into a mathematical space, then produces an approximation of this same acquired sequence from this projection.

An approximated sequence may comprise differences with the acquired time sequence.

In the present application, an approximation error is a quantity representing differences between the acquired values and approximated values respectively corresponding to the same dates. For example, said error is the sum of the differences in absolute value between the elements in the approximated sequence and the elements in the acquired sequence. In another example, said error is the sum of the square of the differences.

The approximation module which determines the approximated time sequence is previously configured (i.e. before implementation of the detection method) to reproduce reference sequences with little approximation error. These reference sequences comprise status indicator values of the same type as the status indicators mentioned in the foregoing.

These reference sequences comprise status indicator values acquired over a plurality of aircraft flights.

The use of the approximation module thus configured advantageously allows the detection of abnormal operation of the component in relation to operation as represented by the reference time sequences. The approximation module is effectively configured to provide better approximations of a plurality of reference time sequences than for one sequence representative of abnormal operation of the component. Therefore, the approximation module allows the distinguishing of abnormal operations and hence the recognition of an anomaly.

In one embodiment, the flights from which the reference sequences were acquired are flights during which no malfunction occurred, and which were followed by a significant number of flights without malfunction. By malfunction, it is meant herein an event causing loss of functionality of a component or possibly affecting the safety of an aircraft (e.g. in-flight engine shutdown, oil leak, oil overheating).

In one embodiment of the method, said approximation module is obtained by a machine learning algorithm from said reference time sequences.

Advantageously, this embodiment allows the detection of abnormal operation based solely on past observations (the reference sequences). This embodiment therefore has the advantage of not requiring a priori knowledge related to the structure and/or parameters of the aircraft. In particular, the use of a machine learning algorithm does not require the determination of a physical model of the aircraft or part of the components thereof.

In one embodiment, said approximation module is an artificial neural network. By «artificial neural network», reference is made herein to a parameterized function comprising one or more layers of artificial neurones connected together.

An artificial neural network e.g. a convolutional neural network accurately learns the normal operation of the component from reference sequences. In particular, a neural network can integrate the information contained in a large volume of data (i.e. a large number of reference sequences). In the case in hand, such information for example concerns particular time patterns of variations in status indicator values. A neural network is therefore able to learn a wide variety of functioning operations and thereby contribute towards improving the reliability of anomaly detection.

The artificial neural network can be implemented on a device of computer type.

In one embodiment, said approximation module is an artificial neural network comprising an encoder and a decoder,
said encoder determining a compressed sequence from said time sequence input into the neural network, said compressed time sequence being of smaller size than said input time sequence,
said decoder performing a reconstruction from the compressed sequence to obtain said approximated time sequence at the output of the neural network,

Said neural network is also called an autoencoder network. It is trained to reconstruct reference sequences. By compressed sequence, it is meant herein a projection of a sequence into a mathematical space, such that the projection is of reduced size compared with the input sequence. For the autoencoder to perform good approximation of a sequence (i.e. with small error of approximation) from compression of this sequence, this compression must comprise sufficient information characterizing this sequence. Therefore, an autoencoder configured according to the invention extracts from a sequence the data that is characteristic of normal operation. If the sequence input into the autoencoder corresponds to abnormal operation, then the compression thereof will not comprise all the information needed to perform good approximation.

In addition, an autoencoder network is capable of recognizing complex time characteristics difficult to detect with an analytical model, and it is therefore able to distinguish with more accuracy between abnormal and normal operation.

When learning to reproduce reference sequences, an autoencoder learns to recognize recurrent patterns and tends to ignore the most infrequent patterns. Therefore, the use of an autoencoder is particularly advantageous for the detection of an anomaly from flight data, since a large majority of aircraft flights do not experience a malfunction. Therefore, when learning from acquired reference sequences over a plurality of past flights, the autoencoder learns to recognize patterns representing flights without malfunction.

In one embodiment, the method for detecting an anomaly is implemented for at least a first and a second acquired time sequence, said second acquired time sequence being determined by sub-sampling said first acquired time sequence, and wherein said time sequence approximated from said acquired sequence is determined by said approximation module configured from reference time sequences of same sampling frequency as this acquired sequence.

Therefore, the invention particularly concerns a method for detecting an operating anomaly, in relation to reference values, of at least one aircraft component associated with at least one status indicator, said method—for at least two acquired time sequences each comprising successive acquired values of said at least one indicator at different instants throughout the operation of said at least one component —comprising steps of:
determining, for each of the acquired time sequences, an approximated time sequence comprising approximated values of said acquired values at said instants for this acquired time sequence, approximation being performed by an approximation module;
determining, for each of said acquired time sequences, a global anomaly score for said acquired time sequence from differences between said acquired values and said approximated values for this acquired time sequence; and
detecting, for each of said acquired time sequences, an operating anomaly of said component as a function of a comparison of said global anomaly score determined for this sequence with a first threshold,
said approximation module previously being configured to minimize approximation errors between time sequences of reference values and time sequences of values approximated from said reference values, said reference values being representative of normal operation, such that approximation errors between said acquired values and said approximated values are greater if the acquired values are representative of abnormal operation, said second acquired time sequence being determined by sub-sampling said first acquired time sequence, said time sequence approximated from said acquired sequence being determined by said approximation module configured from reference time sequences of same sampling frequency as this acquired sequence.

In this embodiment, two acquired time sequences corresponding to one same operating timeframe of the aircraft component are used to detect an anomaly, but these sequences capture variations over different time scales. These two sequences effectively correspond to different sampling frequencies.

Some anomalies are solely detectable on variations over short times (visible insofar as the sampling frequency of the analysed sequence is fairly high), while other anomalies correspond to variations over longer times (therefore more easily detectable with a lower sampling frequency). As a result, this embodiment advantageously allows the detection of a larger number of anomalies.

In this embodiment, the first and second acquired times sequences are respectively approximated by two separate approximation modules, and a global anomaly score is determined for each of the first and second acquired sequences.

In one particular embodiment, the first and the second time sequences can be processed before being input into their respective approximation modules to determine the approximated time sequences.

The processing applied to the first and the second time sequences is smoothing or filtering for example of these sequences.

It is recalled that smoothing is a technique known to persons skilled in signal processing, used for example to improve the quality of data by reducing noise e.g. by averaging successive data in a time sequence.

It is recalled that filtering may entail applying a filter to data in order to extract specific information therefrom by enhancing or attenuating certain frequencies. It can be used to evidence specific signal components, while reducing noise.

In one embodiment of the method, each value of said second time sequence is a mean over an interval of values of said first time sequence, two consecutive values of said second sequence being respectively determined from two contiguous intervals of said first sequence.

In this embodiment, the sub-sampling applied to the first sequence is also a low-pass filter to limit the maximum frequency of the signals in the second sequence. This advantageously allows detection of additional anomalies, in particular anomalies detectable on low frequency signals.

In one embodiment of the method, the step to determine a global anomaly score for each of the one or more time sequences, comprises sub-steps of:
determining a sequence of instant anomaly scores, said instant anomaly score being obtained, for said instant, from the difference between the acquired value and the approximated value of this instant;
said global anomaly score being obtained from a sum of at least some of said instant anomaly scores.

By instant anomaly score, it is meant herein a quantity representing a difference between an acquired value and an approximated value.

In one embodiment, said instant anomaly score is a Mahalanobis distance determined from said difference and parameters of mean and variance. In another embodiment, said instant anomaly score is a difference divided by a mean difference.

In one embodiment of the method, said global anomaly score is obtained from the sum of a sub-assembly of said instant anomaly scores higher than a second threshold.

The inventors have observed that the use of a second threshold conforming to this embodiment advantageously allows a reduction in the number of false-positives in anomaly detection, and hence the obtaining of more reliable detection.

In one embodiment of the method, the calculation of said global anomaly score only takes into account the instant anomaly score of an instant if this instant lies within a consecutive series of instants in which all the instant anomaly scores are higher than said second threshold, said consecutive series comprising a number of instants higher than a set number.

For example, if this set number is 3, only the instant anomaly scores belonging to intervals of at least three scores higher than the second threshold are computed in the sum which determines the global anomaly score.

It is to be pointed out that in embodiments in which several acquired sequences are approximated by different approximation modules respectively, different set numbers can be used to determine the global anomaly score for each of the acquired sequences.

In this embodiment, only the indicator values differing from normal values over a sufficiently long timeframe are taken into account to determine the global anomaly score, and hence the detection of an anomaly. Therefore, this embodiment advantageously allows a reduction in the number of false positives during anomaly detection, and hence the obtaining of more reliable detection.

In one embodiment of the method:
said sum is a sum of a sub-assembly of said instant anomaly scores higher than a second threshold; and
the calculation of said global anomaly score only takes into account the instant anomaly score of an instant if this instant lies within a consecutive series of instants in which all the instant anomaly scores are higher than said second threshold, said consecutive series comprising a number of instants higher than a set number.

In one embodiment of the method, said at least one sum comprises instant anomaly scores within a timeframe starting after a start phase of the operation of said one or more components, and ending before an end phase of the operation of said one or more components.

This embodiment allows limiting of false positives in anomaly detection since the phases of start of operation and end of operation can be subjected to strong variations in status indicator values. This embodiment therefore advantageously allows the obtaining of more reliable detection.

In one embodiment of the method, said at least one status indicator belongs to at least one of the following categories:
oil level;
oil temperature;
oil pressure;
oil filter head loss;
rotation speed of a turbine of said aircraft;
ambient pressure;
ambient temperature;
fuel flow rate;
position of a valve controlling return of fuel to the tank.

Preferably, this embodiment particularly allows reliable monitoring of the operation of an oil circulation system in an engine or turbine engine of an aircraft.

In one embodiment of the method:
said at least one acquired time sequence comprises acquired values of a plurality of status indicators; and
said at least one approximated time sequence comprises approximated values of said acquired values of some of the status indicators of said plurality of indicators, approximation being obtained from the acquired values of said plurality of indicators.

In this embodiment, the approximation module receives inputs of acquired values of a plurality of status indicators (e.g. the indicators in the categories given above), and determines the approximations of only some of these acquired values, in particular the acquired values of some of the plurality of indicators (e.g. only the status indicators of the first four categories given above: oil level, oil temperature, oil pressure and oil filter head loss). The global anomaly score is then determined from differences between the chosen acquired values and the corresponding approximated values. The remaining indicators are then used as contextual information used by the approximation modules.

This embodiment allows an improvement in the reliability of the approximation module (and hence the reliability of anomaly detection) since it uses indicator values able to be correlated with the status indicator values to be approximated. For example, the rotation speed of a turbine can be impacted by the functioning of the oil circulation system (and is therefore correlated with the values of oil level, oil temperature and oil pressure).

In one embodiment, the method comprises a step to identify statuses causing the anomaly.

For example, identification is performed by determining instants at which the instant anomaly scores are higher than the second threshold. The status indicators values at these instants can be compared with mean values or with thresholds to determine which indicators have abnormal values and are therefore responsible for the anomaly.

In one aspect of the invention, there is proposed a computer programme having instructions to implement the steps of a method as described above, when the computer programme is executed by a processor or computer.

The computer programme can be formed of one or more sub-parts stored in one same memory or in separate memories. The programme can use any programming language, and can be in the form of a source code, object code or intermediate code between a source code and object code e.g. in a partially compiled form or in any other desirable form.

In one aspect of the invention, there is proposed a computer-readable data medium comprising a computer programme as described above.

The data medium can be any entity or device capable of storing the programme. For example, the medium can be storage means such as a read-only memory or ROM e.g. a CD-ROM, or a ROM of a microelectronic circuit, or a magnetic recording means e.g. a floppy disk or hard disk. Also, the storage medium can be a transmissible medium such as an electrical or optical signal which can be conveyed via electrical or optical cable, via radio waves or via a telecommunications network, or via a computer network, or by other means. The programme of the invention in particular can be downloaded onto a computer network. Alternatively, the data medium can be an integrated circuit in which the programme is incorporated, the circuit being adapted to execute or to be used for the execution of the method under consideration.

### BRIEF DESCRIPTION OF THE DRAWINGS

Other characteristics and advantages of the present invention will become apparent from the description given below of embodiments of the invention. These embodiments are given as illustrative examples and are not in any way limiting. The description given below is illustrated by the appended drawings:

FIG. 1 in the form of a flow chart illustrates the steps of a detection method according to one embodiment.

FIG. 2 illustrates the functional architecture of a detection device according to one embodiment.

FIG. 3A illustrates sub-steps of the acquisition step of the detection method according to one embodiment. FIG. 3B illustrates a first and a second time sequence according to one embodiment.

FIG. 4 illustrates sub-steps of the step to determine a global anomaly score according to one embodiment.

FIG. 5A and FIG. 5B illustrate a first and a second autoencoder neural network used to implement the step of determining a first and a second approximated time sequence, according to one embodiment.

FIG. 6A illustrates a sequence of instant anomaly scores determined with a detection method according to one embodiment. FIG. 6B illustrates a sequence of values of a status indicator.

FIG. 7 illustrates the structural architecture of an anomaly detection device according to one embodiment.

### DESCRIPTION OF EMBODIMENTS

The present invention concerns a method and device for anomaly detection in one or more components of an aircraft. In the description below, the invention is used to detect operating anomalies of an oil circulation system in an aircraft turbine engine. This particular embodiment is used as an example and is in no way limiting. In particular, the invention can also be applied to an electronic control system of the aircraft, a fuel circulation system, a turbine, an assembly of sensors, or any other functional component of an aircraft.

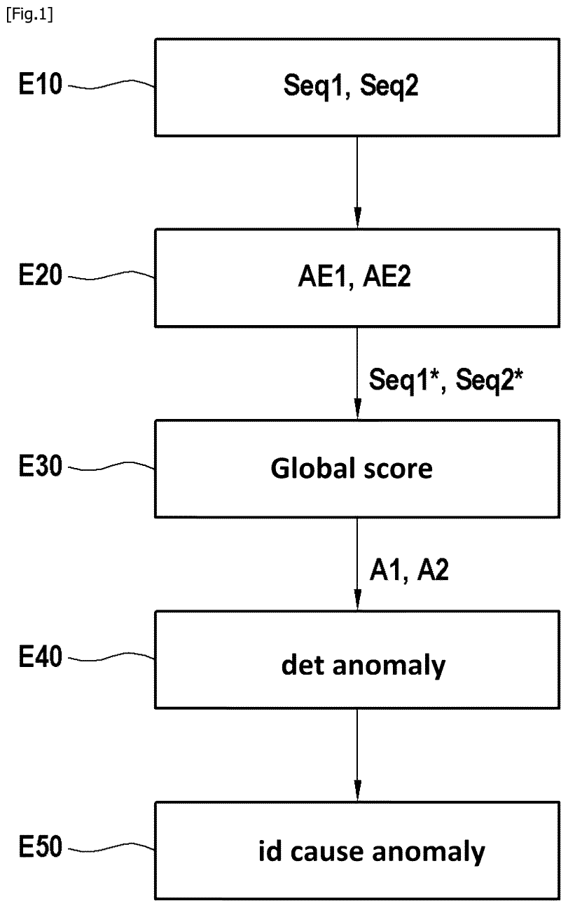

FIG. 1, in flow chart form, illustrates the steps of the anomaly detection method according to one embodiment.

This embodiment comprises a step E10 at which time sequences Seq1 and Seq2 are acquired of status indicators of the oil circulation system during a flight. In this embodiment, each element of a time sequence comprises status indicator values of the system. Each of these values is representative of a status of the system at a given instant or over a given timeframe.

A status indicator is an oil level for example, an oil temperature, oil pressure, rotation speed of an engine turbine, position of a valve, or any other indicator impacted by the functioning of the oil system.

In the example described here, each element of an acquired time sequence comprises the values of 10 status indicators:
an oil temperature value,
an oil level value,
an oil pressure value,
oil filter head loss,
rotation speed of a turbine under low pressure conditions,
rotation speed of a turbine under high pressure conditions,
ambient pressure,
ambient temperature,
fuel flow rate,
position of a valve controlling return of fuel to the fuel tank.

The first four above-mentioned status indicators directly characterize the oil circulation system, while the following are indicators indirectly correlated with the functioning of the oil circulation system.

By oil filter head loss, it is meant a drop in oil pressure at the filter, e.g. caused by oil friction with the filter.

The six other indicators do not directly characterize the oil circulation system, but their values are impacted by the functioning of the oil system. Therefore, the trend in these indicators over time provides relevant information on the status of the oil system. In the remainder hereof, these six indicators are said to be contextual.

In this example, the engine (e.g. a turbine engine) comprises two turbines operating at two different pressure levels: low and high pressure.

By ambient pressure and temperature, it is meant the pressure and temperature outside the aircraft.

The invention also covers embodiments in which a single status indicator is used and wherein each element of a time sequence comprises only one status indicator value.

The status indicators are derived for example from measurements taken by sensors linked to a backup system recording the measurements taken by these sensors over time. These indicators are therefore measured and successively recorded throughout the functioning of the oil system, and in particular during the flight of the aircraft.

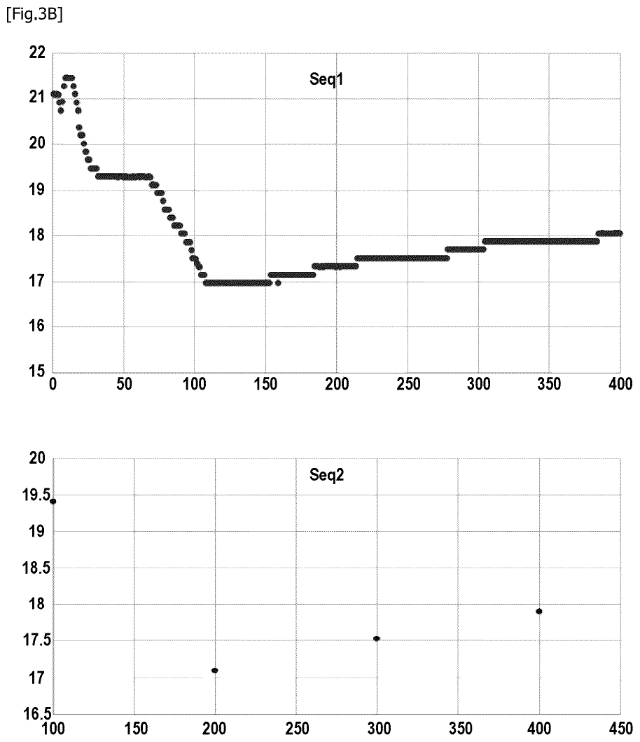

FIG. 3A illustrates an embodiment in which the acquisition step E10 comprises two sub-steps E11 and E12. At sub-step E11, status indicator values forming a first time sequence Seq1 are acquired.

For example, these values correspond to measurements taken at regular time intervals during the operation of the oil system. For example, these measurements were taken every second. Therefore, in this example, the first time sequence Seq1 corresponds to a sampling frequency of 1 Hertz.

At sub-step E12, a second time sequence Seq2 is determined from the first sequence Seq1 by sub-sampling.

FIG. 3B illustrates an example of values acquired over a timeframe (of 400 seconds) forming a time sequence Seq1, and an example of a time sequence Seq2 determined by sub-sampling sequence Seq2. In this example, only one status indicator value is illustrated (in particular oil level) per time point.

In this example, the sampling frequency of sequence Seq1 is 1 Hz (one value per second) while the sampling frequency of sequence Seq2 is 10 mHz (one value every 100 seconds).

In one embodiment, sub-sampling entails:
decomposing the first sequence into contiguous intervals each of K elements, and
determining the mean of the elements in each interval,
the second sequence being the sequence of the means obtained.

In this embodiment, sub-sampling allows both the dividing of the sampling frequency of the first sequence by K, and the application of a low-pass filter which divides the frequency of the signals of the first sequence by K. For example, in the example described here, the number K is chosen to be 100. In this case, sequence Seq2 corresponds to a sampling frequency of 10 mHz

In a simplified example to illustrate the above-mentioned embodiment, the first acquired time sequence comprises four elements, each element comprising two status indicator values: (3; 4), (2; 3), (4; 5) and (4; 6). In this example K is 2, the second sequence is therefore determined by calculating the mean of elements (3; 4) and (2; 3) and the mean of elements (4; 5) and (4; 6). The second sequence therefore comprises the two elements (2.5; 3.5) and (4; 5.5).

The invention is not limited to the sub-sampling method just described. For example, in another embodiment, sub-sampling entails selecting an element of the first sequence every K element. In this case, the sampling sequence of the second sequence is equal to the sampling frequency of the first sequence divided by K.

At step E20, approximation modules AE1 and AE2 perform approximations of the respective sequences Seq1 and Seq2, and thereby determine approximated sequences Seq1* and Seq2*.

In the embodiment described here, the modules AE1 and AE2 are autoencoder neuronal networks.

In this embodiment, module AE1 has been trained to approximate a first group of reference sequences corresponding to the same sampling frequency as that of sequence Seq1 (e.g. 1 Hz), and module AE2 has been trained to approximate a second group of reference sequences corresponding to the same sampling frequency as sequence Seq2 (e.g. 10 mHz).

The reference sequences of the second group are determined for example from the sequences of the first group, using the same sub-sampling method allowing Seq2 to be obtained from Seq1.

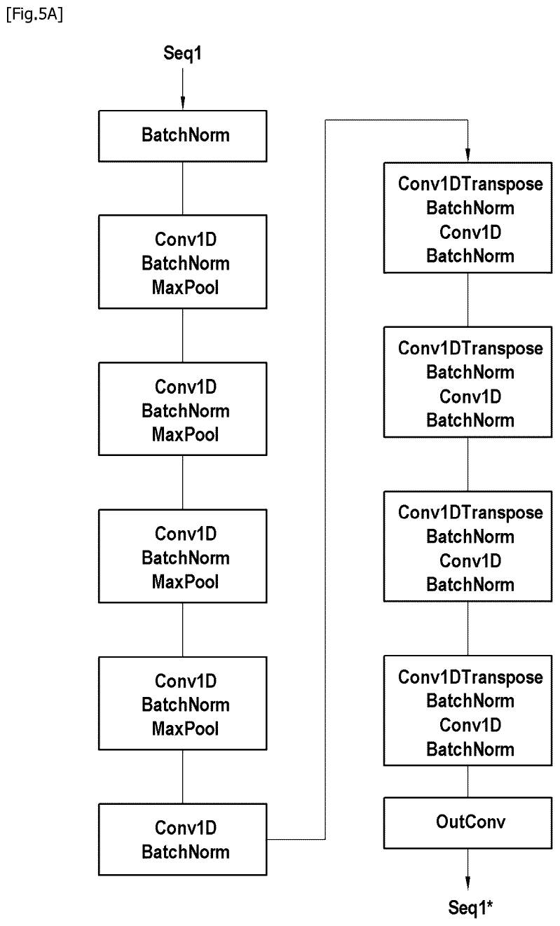

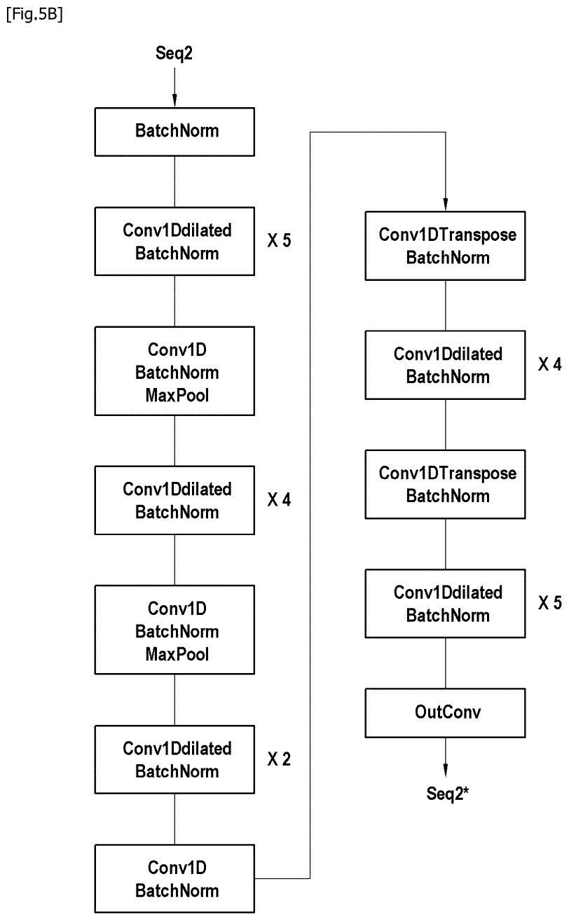

FIG. 5A illustrates an example of an architecture of the autoencoder network AE1.

This network comprises an encoder performing compression of the input sequence Seq1. It comprises five convolution layers Conv1D preceded (preceded in the direction of input to output) by batch normalization layers (BatchNorm). With the exception of the OutConv layers described below, the convolution layers Conv1D all comprise a nonlinear activation layer at the output of convolution. The convolution layers Conv1D are also followed by Max Pooling layers, except the last convolution layer. These pooling layers reduce the length of the sequence input into the network, thereby allowing compression thereof. The five convolution layers Conv1D of the encoder respectively comprise filters of size 20, 40, 60, 80 and 100. The size of a filter corresponds to the size of the elements output from the convolution layer. For example, the first convolution layer receives an input of a sequence of elements each comprising 10 values, and outputs a sequence of elements each comprising 20 values, these values corresponding to projection of elements of the input sequence into a mathematical space of size 20.

This encoder is followed by a decoder which determines sequence Seq1* from the output of the encoder. This decoder comprises four composite layers, each composite layer being formed of a deconvolution layer Conv1DTranspose followed by a BatchNorm layer, a Conv1D layer followed by another BatchNorm layer. The deconvolution layers Conv1DTranspose of the decoder respectively have filters of size 100, 80, 60 and 40. The convolution layers Conv1D of the decoder respectively have filters of size 80, 60, 40 and 20. The last layer OutConv of the decoder is a convolution layer with a filter of size 10. The OutConv layer outputs sequence Seq1 *.

FIG. 5B illustrates an example of architecture of the autoencoder network AE2.

The encoder AE2 comprises three multiple convolution layers Conv1D and three dilated convolution layers Conv1Ddilated, each followed by a BatchNorm layer. Each of the multiple dilated convolution layers Conv1 Ddilated is a stack of several dilated convolution layers with filters of same size, followed by BatchNorm layers. The three multiple dilated convolution layers of the encoder each comprise 5, 4 and 2 stacked layers respectively. Each dilated convolution layer has a dilation pitch of 2. These dilated convolution layers allow the detection of anomalies occurring over a long time period.

With the exception of the last layer, the convolution layers Conv1D are followed by a Max Pooling layer. The six convolution layers of the encoder respectively comprise filters of size 64, 64, 96, 96, 128 and 128.

The decoder of AE2 has two deconvolution layers, two multiple dilated convolution layers and a convolution layer, each followed by a BatchNorm layer. The deconvolution layers of the encoder respectively have filters of size 128 and 96, while the convolution layers thereof respectively have filters of size 128 and 96. The two multiple dilated convolution layers of the encoder each have 4 and 5 layers respectively.

The last layer OutConv of the decoder is a convolution layer with a filter of size 10. The OutConv layer outputs sequence Seq2 *.

The invention is not limited to the architectures of autoencoder networks illustrated in FIGS. 5A and 5B. In other embodiments, autoencoder networks can have a number of layers and parameters differing from the networks described above. In some embodiments, the autoencoder networks comprise recurrent neural layers, transformer layers of encoder and/or decoder type, or any other architecture allowing analysis of time sequences.

Also, the invention does not restrict the approximation modules to autoencoder networks. In other embodiments, the approximation modules perform regressions as previously mentioned. These regressions can be produced by machine learning models such as artificial neural networks. In some embodiments, the approximation modules perform regressions as indicated by applying an analytical model of the trend in statuses of the monitored components. Said analytical model is a Kalman filter for example.

The module AE1 receives sequence Seq1 at its input. In the example described here, the encoder determines a compressed sequence by passing sequence Seq1 through its successive layers. The compressed sequence then passes through the successive layers of the decoder of AE1 which outputs the approximated sequence Seq1*. The process is similar for determination of sequence Seq2* approximated from Seq2 with module AE2.

The autoencoder AE1 has been trained from a set of reference sequences. These reference sequences were acquired during flights of a group of aircraft. In the example described here, each element of a reference sequence contains values of the same 10 status indicators previously mentioned and contained in sequence Seq1.

In one embodiment, the reference sequences are derived from flights judged to be «sound» i.e. without any malfunction during the flight, and which were followed by at least a significant number of flights (e.g. 10) without any malfunction.

When being trained, the autoencoder is configured to minimize approximation errors between the reference sequences and sequences determined by the autoencoder. For example, the training of AE1 comprises a plurality of steps, each comprising:
determination of a sequence from a reference sequence;
calculation of an approximation error between the sequence thus determined and the corresponding reference sequence;
modification of the parameters of the autoencoder AE1 to minimize the approximation error thus calculated.

Modification of the parameters of the autoencoder AE1 to minimize approximation errors can be obtained with a gradient descent algorithm. The gradient descent algorithm is intended to correct errors according to the extent each parameter contributes thereto.

The approximation error is for example a mean squared error between the values of the sequence determined by AE1 and the values of corresponding reference sequence.

The reference sequences used to train the autoencoder AE2 are determined in the same manner as sequence Seq2 is determined from sequence Seq1. Therefore, each reference sequence used to train AE2 is determined by sub-sampling a reference sequences used to train AE1.

The training of AE2 is similar to the training of AE1.

At step E30, global anomaly scores A1 and A2 are determined for sequences Seq1 and Seq2 respectively.

In some embodiments, the modules AE1 and AE2 determine approximated values of only some of the status indicators. For example, the time sequences input into modules AE1 and AE2 contain acquired values of the ten status indicators mentioned in the foregoing (the indicators directly characterizing the oil system and the contextual indicators), and the approximated values correspond to the four status indicators directly characterizing the oil circulation system, in particular:
oil temperature,
oil level,
oil pressure, and
oil filter head loss.

Also, in this same example, the global anomaly scores are determined from differences between the acquired values corresponding to these four status indicators and the corresponding approximated values. Therefore, in this example, the global anomaly scores A1 and A2 do not take into account the values of contextual indicators.

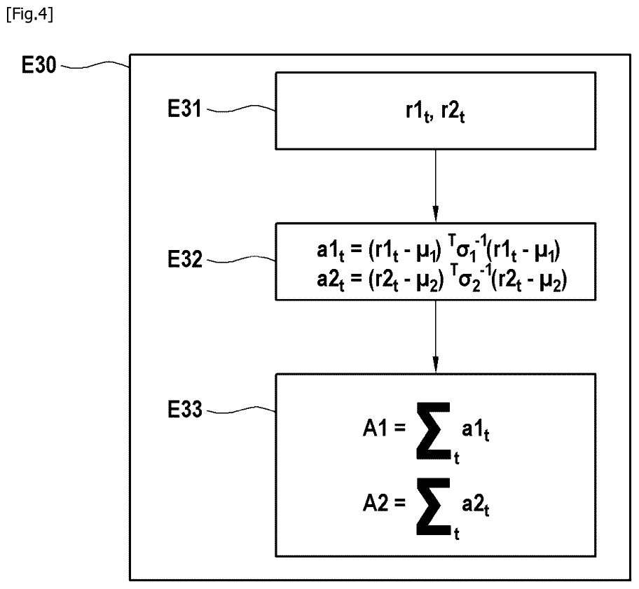

FIG. 4 illustrates sub-steps of step E30 in one embodiment.

At sub-step E31, for each element at an instant t of sequence Seq1, a difference r1ₜ is calculated between this element and the corresponding approximated element. In a simplified example for illustration purposes, sequence Seq1 comprises two elements each comprising three status indicator values: (3; 4; 1) and (2; 3; 2). In this example, sequence Seq1* approximated by AE1 comprises the two elements (3.1; 4.2; 0.8) and (2.5; 2.7; 1.9). In this case, the differences between sequence Seq1 and sequence Seq1* are the two elements (−0.1; −0.2; 0.2) and (−0.5; 0.3; 0.1).

In the same manner, the differences r2ₜ are calculated between sequence Seq2 and sequence Seq2* approximated from Seq2.

At sub-step E32, from each difference r1ₜ (r2ₜ), an instant anomaly score alt (a2ₜ) is calculated. For example, said instant anomaly score is a Mahalanobis distance. In this case, an instant anomaly score alₜ or a2ₜ is calculated with the following formulas:

$$a {1}_{t} = {( r {1}_{t} - {μ}_{1} )}^{T} {σ}_{1}^{- 1} ( r {1}_{t} - {μ}_{1} ) \qquad [ Math 1 ]$$

$$a {2}_{t} = {( r {2}_{t} - {μ}_{2} )}^{T} {σ}_{2}^{- 1} ( r {2}_{t} - {μ}_{2} ) \qquad [ Math 2 ]$$

Where μ₁ is a mean difference and σ₁⁻¹ is the inverse of a covariance matrix σ₁. If a difference r1ₜ comprises a single value, μ₁ comprises a single value, and σ₁ also comprises a single value. If a difference is a vector comprising several values, μ₁ is a vector with as many values. The parameter μ₁ can be determined by calculating, with the trained autoencoder AE1, a mean of differences calculated from reference sequences and sequences approximated by AE1 from these reference sequences. In the same manner, the covariance matrix σ₁ can be determined from covariances between reference values and values approximated by AE1.

In the same manner, the parameters μ₂ and σ₂ are parameters of mean and covariance determined from the trained autoencoder AE2.

The invention is not limited to the choice of a Mahalanobis distance. For example, in another embodiment, an instant anomaly score corresponding to an instant t is a mean of the absolute values of the difference values r1ₜ or r2ₜ.

At sub-step E33, the global anomaly scores A1 and A2 are determined from sequences of instant anomaly scores a1ₜ and a2ₜ.

In the embodiment illustrated in FIG. 4, a global anomaly score A1 (A2) is a sum Σₜa1ₜ(Σₜa2ₜ) of instant anomaly scores a1ₜ (a2ₜ).

In one embodiment, an anomaly score A1 (A2) is the sum of instant anomaly scores a1ₜ (a2ₜ) higher than a fixed threshold S2. This threshold S2 can be determined as a quantile of a group of instant anomaly scores calculated from a group of reference sequences with the module AE1 (AE2). For example, this threshold S2 can be equal to the 99^{the} quantile of this group of instant anomaly scores.

It is to be pointed out that in some embodiments, different threshold values S2 and S2′ can be chosen for the scores alt determined from autoencoder AE1 and for the scores a2ₜ determined from autoencoder AE2.

In one embodiment, only the intervals of more than N instant anomaly scores higher than threshold S2 are taken into account in the sum which determines the global anomaly score A1 (A2), where N is a set number.

In some embodiments, only the intervals of more than N instant anomaly scores higher than threshold S2 are taken into account in the sum which determines the global anomaly score A1, and only the intervals of more than N′ instant anomaly scores higher than threshold S2′ are taken into account in the sum which determines the global anomaly score A2, N and N′ being independently set numbers for each autoencoder AE1 and AE2. For example, N can be chosen to be 1 to detect one-time anomalies, and N′ chosen to be 2 to detect recurrent anomalies.

At step E40, each global anomaly score A1 and A2 is compared with a threshold S1. For example, this threshold is equal to the 98^{th} quantile of a group of global anomaly scores determined from a group of reference sequences with the modules AE1 and AE2.

In some embodiments, the global anomaly scores A1 and A2 are respectively compared with different thresholds S1 and S1′. For example, S1 is equal to the 98^{th} quantile of a group of global anomaly scores determined from a group of reference sequences with module AE1, and S1′ is equal to the 98^{th} quantile of a group of global anomaly scores determined from a group of reference sequences with module AE2.

In one embodiment, if the anomaly score A1 is higher than threshold S1, or if the score A2 is higher than threshold S1′, then the anomaly is detected.

It is to be noted that the thresholds S1 and S2 and the number N (as well as S1′, S2′ and N′), mentioned above, are parameters able to be chosen so as to optimize anomaly detection over a group of reference sequences.

For example, these reference sequences may comprise sequences corresponding to flights without any detected malfunction, and flights during which occurrences of malfunction were detected, for example using conventional methods. In this case, the parameters S1, S2 and N can be chosen so as jointly to minimize the number of false positives and the number of false negatives when detecting anomalies from these reference sequences. In this example, a false positive corresponds to the detection of an anomaly (global anomaly score higher than threshold S1) on a reference sequence although this sequence corresponds to a flight without malfunction. Conversely, a false negative corresponds to the non-detection of an anomaly (global anomaly score lower than the threshold S1) on a reference sequence corresponding to a flight having a malfunction.

At step E50, the status indicators causing an anomaly detected at step E40 are identified.

For example, at this step, the instants at which the instant anomaly scores are higher than threshold S2 are identified. For these identified instants, the status indicators are then identified for which the differences r1ₜ and r2ₜ between the acquired values and approximated values are the greatest. Therefore, the status indicator(s) of which the approximated values differ the most from the acquired values represent the status responsible for the anomaly.

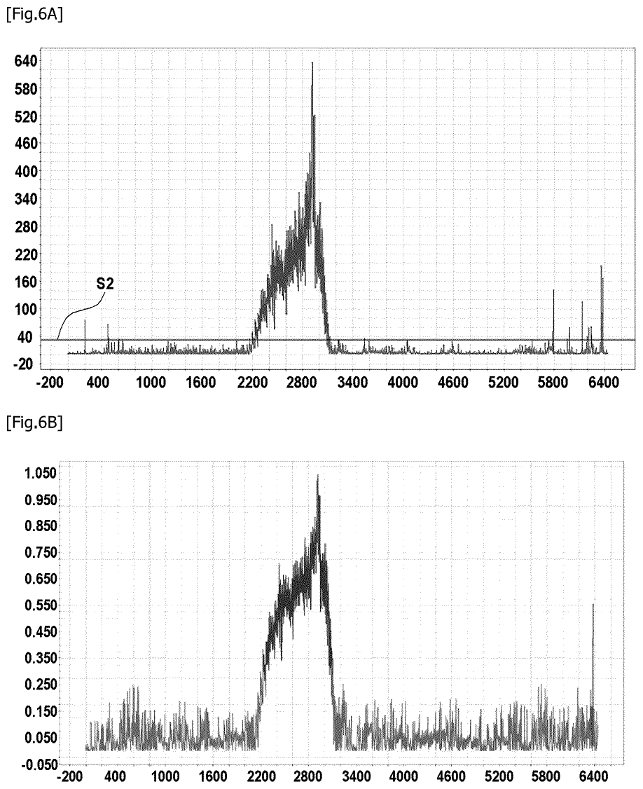

FIGS. 6A and 6B illustrate an example in which abnormal variations in the oil level are the cause of the anomaly.

FIG. 6A illustrates instant anomaly scores over time, and the threshold S2 is represented by a horizontal line. Between the time points 2200 and 3200, the instant anomaly scores are higher than threshold S2.

FIG. 6B illustrates the differences over time between the acquired values of oil level and the corresponding approximated values. Between the time points 2200 and 3200, the approximated values of oil level differ largely from the acquired values, indicating that the oil level is responsible for the anomaly, in other words that the trend in oil level during this flight is abnormal.

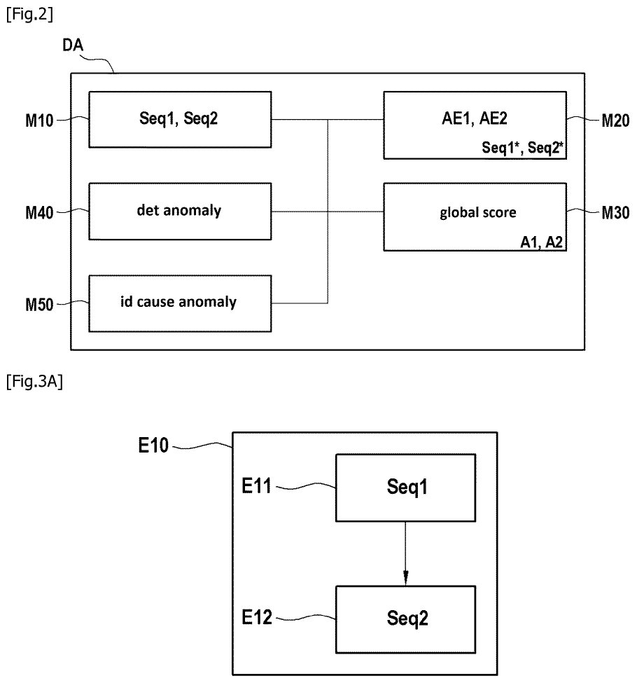

FIG. 2 illustrates the functional architecture of an anomaly detection device DA configured to implement the steps of the anomaly detection method illustrated in FIG. 1. The device DA comprises:
a module M10 to implement step E10, to acquire sequences of status indicator values Seq1 and Seq2;
a module M20 to implement step E20, to determine sequences of approximated values Seq1* and Seq2*, this module comprising the previously described approximation modules AE1 and AE2;
a module M30 to implement step E30, to determine global anomaly scores A1 and A2 for sequences Seq1 and Seq2;
a module M40 to implement step E40, to detect an operating anomaly; and
a module M50 to implement step E50, to identify statuses causing the anomaly.

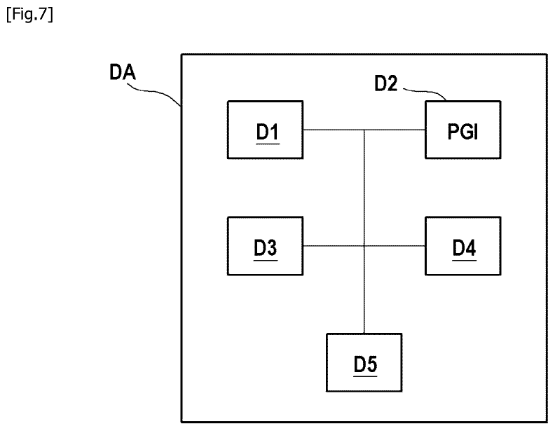

FIG. 7 illustrates the structural architecture of an anomaly detection device DA conforming to one particular embodiment of the invention.

In the embodiment described here, the device DA has the structural architecture of a computer. In particular, it comprises a processor D1, a read-only memory D2, a random-access memory D3, a rewriteable non-volatile memory D4 and communication means D5.

The read-only memory D2 of the device DA forms a recording medium conforming to the invention, readable by the processor D1 and on which a computer programme PGI conforming to the invention is recorded, this programme comprising instructions for execution of the steps of an anomaly detection method according to the invention and previously described with reference to FIG. 1.

The computer programme PGI defines functional modules of the device DA illustrated in FIG. 2.

1. A method for detecting an operating anomaly in relation to reference values, of at least one aircraft component associated with at least one status indicator, said method-for at least two acquired time sequences each comprising successive acquired values of said at least one indicator at different instants throughout the operation of said at least one component—comprising steps of:
determining, for each of the acquired time sequences, an approximated time sequence comprising approximated values of said acquired values at said instants for this acquired time sequence, approximation being performed by an approximation module;
determining, for each of said acquired time sequences, a global anomaly score from differences between said acquired values and said approximated values for this acquired time sequence; and
detecting, for each of said acquired time sequences, an operating anomaly of said component as a function of a comparison of said global anomaly score determined for this sequence with a first threshold,
said approximation module previously being configured to minimize approximation errors between time sequences of reference values and time sequences of values approximated from said reference values, said reference values being representative of normal operation, such that approximation errors between said acquired values and said approximated values are greater if the acquired values are representative of abnormal operation, said second acquired time sequence being determined by sub-sampling said first acquired time sequence, said time sequence approximated from said acquired sequence being determined by said approximation module configured from reference time sequences of same sampling frequency as this acquired sequence.

2. The method according to claim 1, wherein each value of said second time sequence is a mean over an interval of values of said first time sequence, two consecutive values of said second sequence being respectively determined from two contiguous intervals of said first sequence.

3. The method according to claim 1, comprising processing of said first and second time sequences before being input into their approximation modules, for example filtering or smoothing of these sequences.

4. The method according to claim 1, wherein said approximation module is obtained with a machine learning algorithm from said reference time sequences.

5. The method according to claim 4, wherein said approximation module is an artificial neural network comprising an encoder and decoder,
said encoder determining a compressed sequence from said time sequence input into the neural network, said compressed time sequence being of smaller size than said input time sequence,
said decoder performing a reconstruction from the compressed sequence to obtain said approximated time sequence at the output of the neuronal network.

6. The method according to claim 1, wherein the determination step of a global anomaly score for each of the one or more time sequences, comprises sub-steps of:
determining a sequence of instant anomaly scores, said instant anomaly score being obtained, for said instant, from the difference between the acquired value and the approximated value of this instant;
said global anomaly score being obtained from a sum of at least some of said instant anomaly scores.

7. The method according to claim 6, wherein:
said sum is a sum of a sub-assembly of said instant anomaly scores higher than a second threshold; and
the calculation of said global anomaly score only takes into account the instant anomaly score of an instant if this instant lies within a consecutive series of instants in which all the instant anomaly scores are higher than said second threshold, said consecutive series comprising a number of instants higher than a set number.

8. The method according to claim 6, wherein said sum comprises instant anomaly scores within a timeframe starting after an operating start phase of said one or more components, and ending before an operating end phase of said one or more components.

9. The method according to claim 1, wherein said component is an oil circulation system, and said at least one status indicator belongs to at least one of the following categories:
oil level;
oil temperature;
oil pressure;
oil filter head loss;
rotation speed of a turbine of said aircraft;
ambient pressure;
ambient temperature;
fuel flow rate;
position of a valve controlling return of fuel to the tank.

10. The method according to claim 1. comprising an identification step of statuses causing the anomaly.

11. A device to detect an operating anomaly in relation to reference values, of at least one component of an aircraft associated with at least one status indicator, said device—for at least two acquired time sequences each comprising successive acquired values of said at least one indicator at different instants throughout operation of said at least one component —comprising:
a determination module, for each of said acquired time sequences, of an approximated time sequence comprising approximated values of said acquired values at said instants for this acquired time sequence, approximation being performed by an approximation module;
a determination module, for each of said acquired time sequences, of a global anomaly score from differences between said acquired values and said approximated values for this acquired time sequence; and
a detection module, for each of said acquired time sequences, of an operating anomaly of said component as a function of a comparison of said global anomaly score, determined for this sequence, with a first threshold, said approximation module previously being configured to minimize approximation errors between time sequences of reference values and time sequences of values approximated from said reference values, said reference values being representative of normal operation, such that approximation errors between said acquired values and said approximated values are greater if the acquired values are representative of abnormal operation, said second acquired time sequence being determined by sub-sampling said first acquired time sequence, said time sequence approximated from said acquired sequence being determined by said approximation module configured from reference time sequences of same sampling frequency as this acquired sequence.

12. (canceled)

13. (canceled)

14. A non-transitory computer readable medium having stored thereon instructions which, when executed by a processor, cause the processor to implement the method of claim 1.
